(19) United States
(12) Patent Application Publication
(10) Pub. No.: US 2023/0298773 A1
(43) Pub. Date: Sep. 21, 2023

(54) MOLTEN SALT-METAL REACTOR FOR IMPLEMENTING MICRO-REACTOR

(71) Applicants: Korea Advanced Institute of Science and Technology, Daejeon (KR); IUCF-HYU (Industry-University Corporation Foundation Hanyang University), Seoul (KR)

(72) Inventors: Yong Hee KIM, Daejeon (KR); Sung Joong KIM, Seoul (KR); Won Jun CHOI, Seoul (KR); Juhyeong LEE, Seoul (KR); Seongdong JANG, Daejeon (KR); Taesuk OH, Daejeon (KR); Eunhyug LEE, Daejeon (KR)

(73) Assignees: Korea Advanced Institute of Science and Technology, Daejeon (KR); IUCF-HYU (Industry-University Cooperation Foundation Hanyang University), Seoul (KR)

(21) Appl. No.: 17/864,311

(22) Filed: Jul. 13, 2022

(30) Foreign Application Priority Data
Mar. 18, 2022 (KR) 10-2022-0033690
Apr. 1, 2022 (KR) 10-2022-0040858

(51) Int. Cl. G21C 3/54; G21C 1/32; G21C 3/52; G21C 11/06; G21C 15/12

(52) U.S. Cl. CPC G21C 3/54; G21C 1/322; G21C 3/52; G21C 11/06; G21C 15/12

(57) ABSTRACT

The present invention relates to a molten salt-metal reactor for implementing a micro-reactor, and more specifically, to a molten salt-metal reactor including a liquid metal nuclear fuel and a molten salt coolant, wherein the molten salt coolant is disposed in an upper portion of the liquid metal nuclear fuel such that the heat generated from the nuclear fuel is transferred to the molten salt coolant and cooled.

### CROSS-REFERENCES TO RELAYED APPLICATION

This patent application claims the benefit of priority from Korean Patent Application No 10-2022-0033690 filed on Mar. 18, 2022 and Korean Patent Application No. 10-2022-0040858 filed on Apr. 1, 2022, the contents of which are incorporated herein by reference.

### BACKGROUND OF THE INVENTION

### Field of the Invention

The present disclosure relates to a molten salt-metal reactor for implementing a micro-reactor.

### Description of the Related Art

A molten salt reactor (MSR) is a candidate for the six Generation-IV nuclear reactors, which are currently receiving great attention and are actively being researched. An MSR refers to a reactor, in which the fuel matrix substituted within a salt is dissolved in a molten salt and used as a nuclear fuel as well as a coolant. An MSR is characterized by excellent safety due to the potential exclusion of the risk of severe accidents and hydrogen explosion, easy residual heat removal in case of emergency, and a strong negative feedback effect due to thermal expansion of the fuel salt.

A representative prior research of a molten salt reactor (MSR) has been conducted on a thermal neutron spectrum MSR developed by Oak Ridge National Laboratory (ORNL), but the thermal neutron spectrum molten salt reactor bears technical issues such as reduced nuclear proliferation resistance due to real-time reprocessing of molten salt fuels, the massive generation of graphite moderator waste, and the generation of a large amount of tritium. Meanwhile, research and development of a molten salt fast reactor (MSFR) which may overcome the shortcomings of a thermal neutron spectrum MSR is being actively conducted overseas (Brovchenko, M., Merle-Lucotte, E., Heuer, D., & Rineiski, A. (2013, June). Molten Salt Fast Reactor transient analyses with the COUPLE code. In American Nuclear Society 2013 Annual Meeting).

FIG. 1 is a conceptual view simply showing the structure of a molten salt fast reactor (MSFR) 100. The overall shape of a reactor vessel 120 is cylindrical, and a neutron reflector 140 surrounds the outside of an active core filled with a liquid fuel 110 to improve neutron economy. On the outside of the reflector 140, a heat exchanger 130 connected to the active core is positioned, and a molten salt fuel circulates through the active core and the heat exchanger. In particular designs of a molten salt fast reactor (MSFR), a radial blanket 150 is installed inside an active core to increase a fuel conversion ratio, in which case a real-time fuel reprocessing process is required to utilize a fissile nuclear fuel generated in the blanket 150, which incurs concerns regarding nuclear proliferation resistance. Therefore, most designs of a molten salt fast reactor (MSFR) do not employ a blanket.

Meanwhile, in developing a molten salt reactor (MSR), one of the areas where technological innovation is required is the implementation of a micro-reactor. A micro-reactor as defined in the present document refers to a nuclear reactor that is small enough to be loaded into a shipping container. The micro-reactor has the advantage of being easily transported while achieving extremely high safety, and thus, may be widely used in various industrial fields, and in particular, may be applied to space reactors that are being competitively developed in the United States, China, and the like. Typical containers have a width of approximately 235 cm, and a height of approximately 239 cm or approximately 270 cm depending on the type. Therefore, in order to implement a micro-reactor, the size of a system is required to be 230 cm or less in width and 230 to 260 cm in height.

Candidate molten salts evaluated to be feasible in a molten salt fast reactor (MSFR) include 67NaCl-33UCl₃, 46KCl-54UCl₃, and the like. Even when 19.75% enriched uranium is used while postulating a cylindrical shape reactor core with the same diameter and height, the minimum diameter of the core for criticality is approximately 215 cm when 67NaCl-33UCl₃ is used, and approximately 190 cm when 46KCl-54UCl₃ is used, which are sizes that make it impossible to load the reactor into a standard container even before taking a device such as a reflector or a heat exchanger into account. In addition, in a typical molten salt reactor (MSR) design, a nuclear fuel is present not only in an active core but also in an inactive region including a heat exchanger, so that a very large amount of 19.75% enriched uranium fuel, amounting to about 20 to 30 tons, is required simply for criticality. For the long-life operation of the nuclear reactor, the initial excess reactivity should be high, but the nuclear fuel conversion ratio of these cores is not high enough insinuating a fundamental disadvantage concerning the initial excess reactivity which cannot be substantially increased due to the limitations of reactivity control. The addition of a blanket and the like to overcome these shortcomings may complicate reactor designs and create new problems. Whereupon, it is almost impossible to design a typical molten salt fast reactor (MSFR), which dissolves and then uses a nuclear fuel in a molten salt, in a micro size, a completely new approach is required to implement a micro-reactor capable of achieving long-term operation while maintaining a simple structure.

Therefore, the present inventors have developed a molten salt-metal nuclear reactor (MSMR) of a novel structure, which has the advantages of a molten salt reactor (MSR) and may be implemented into a micro size, and have completed the present invention.

### SUMMARY OF THE INVENTION

Embodiments of the present invention are directed to provide a molten salt-metal reactor (MSMR) which enables a micro-reactor implementation.

According to an aspect of the present invention, a molten salt-metal reactor comprises a liquid metal nuclear fuel and a molten salt coolant, wherein the molten salt coolant is disposed in an upper portion of the liquid metal nuclear fuel such that the heat generated from the nuclear fuel is transferred to the molten salt coolant and cooled.

The liquid metal nuclear fuel is a uranium-metal alloy.

In addition, the uranium-metal alloy includes uranium having a degree of enrichment of 19.75% or less, and preferably, contains the uranium in an amount of 70 wt % to 99 wt % based on the total weight.

In addition, the uranium-metal alloy preferably includes one metal selected from the group consisting of Fe, Mn, Cr, Ce, Pu, and a combination thereof.

The molten salt coolant includes one selected from the group consisting of NaCl, MgCl₂, KCl, ZnCl₂, NaOH, NaF, KF, ZrF₄, LiF, BeF₂, and a mixture thereof.

The molten salt-metal reactor may include a containment vessel, a reactor vessel disposed inside the containment vessel, and including a lower region which includes the liquid metal nuclear fuel and an upper region which includes the molten salt coolant, a primary heat exchanger disposed in the upper region of the reactor vessel, a neutron reflector surrounding the outside of the reactor vessel, and a reactivity control device disposed between the inner wall of the containment vessel and the outer wall of the reactor vessel.

In addition, the molten salt-metal reactor (MSMR) may further include a pump device configured to circulate the molten salt coolant.

In addition, the molten salt-metal reactor (MSMR) may further include a gas plenum disposed at the uppermost end of the reactor vessel, and storing an inert gas produced by nuclear fission.

In addition, the molten salt-metal reactor (MSMR) may further include an off-gas system connected to the gas plenum for removing inert gas.

In addition, the molten salt-metal reactor (MSMR) may further include a secondary heat exchanger connected to the primary heat exchanger.

In addition, the molten salt-metal reactor (MSMR) may further include a secondary coolant system in which a coolant circulates through the first heat exchanger, the second heat exchanger, the outer surface of the reactor vessel, and the first heat exchanger.

In addition, the molten salt coolant may include a nuclear fuel salt.

In addition, the molten salt-metal reactor (MSMR) may include a plurality of the reactor vessels.

In addition, the molten salt-metal reactor further includes a plurality of heat pipes formed by extending from the upper region to the lower region of the reactor vessel, wherein the plurality of heat pipes is connected to the primary heat exchanger.

In addition, the molten salt-metal reactor (MSMR) is a micro-reactor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram showing the structure of a typical molten salt fast reactor (MSFR);

FIG. 2 is a conceptual diagram showing the structure of a molten salt-metal reactor (MSMR) according to an embodiment of the present invention;

FIG. 3 is an equilibrium phase diagram of uranium (U) and iron (Fe);

FIG. 4 is a diagram showing the specifications of a molten salt-metal reactor (MSMR) used for computational analysis using Serpent, which is a Monte Carlo-based core analysis computer code, to evaluate the reactivity of a molten salt-metal reactor (MSMR) according to an embodiment;

FIG. 5 is a core reactivity change graph according to the burnup period of a molten salt-metal reactor (MSMR) according to an embodiment;

FIG. 6 and FIG. 7 are conceptual diagrams showing the structure of a modular molten salt-metal reactor (MSMR) according to another embodiment of the present invention; and

FIG. 8 and FIG. 9 are conceptual diagrams showing the structure of a modular molten salt-metal reactor (MSMR) including a heat pipe according to yet another embodiment of the present invention.

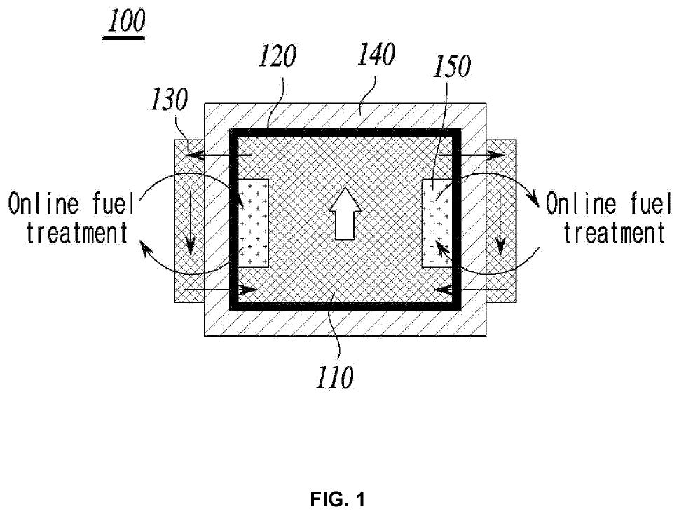

### DETAILED DESCRIPTION OF THE INVENTION

Hereinafter, embodiments of the present invention will be described in detail with reference to the accompanying drawings. However, it should be understood that the present invention is not limited to the following embodiments, but includes all modifications, equivalents, and alternatives falling within the spirit and technical scope of the present invention.

The terms used herein are used only to describe specific embodiments, and the present invention is not limited thereto.

Throughout the specification and claims, when an element is referred to as being “connected” or “accessed” to other elements, the element may be directly connected or accessed to the other elements, but it should be also understood that another element may be present therebetween. In addition, it should be understood that the terms such as “comprise,” or “have” are only intended to specify the presence of features, numbers, steps, operations, elements, components, or combinations thereof described herein, but do not preclude the presence or addition of one or more other features, numbers, steps, operations, elements, components, or combinations thereof.

In addition, unless otherwise defined, all the terms used herein, including technical or scientific terms, have the same meanings as those commonly understood by those skilled in the art to which the present invention pertains. Terms such as those defined in a dictionary commonly used should be construed as having meanings consistent with meanings in the context of the related art, and should not be construed as having ideal or overly formal meanings unless explicitly defined in the present specification.

An aspect of the present invention provides a molten salt-metal reactor including a liquid metal nuclear fuel and a molten salt coolant, wherein the molten salt coolant is disposed in an upper portion of the liquid metal nuclear fuel such that the heat generated from the nuclear fuel is transferred to the molten salt coolant and cooled.

Hereinafter, a molten salt-metal reactor (MSMR) according to an embodiment will be described in detail with reference to the accompanying drawings.

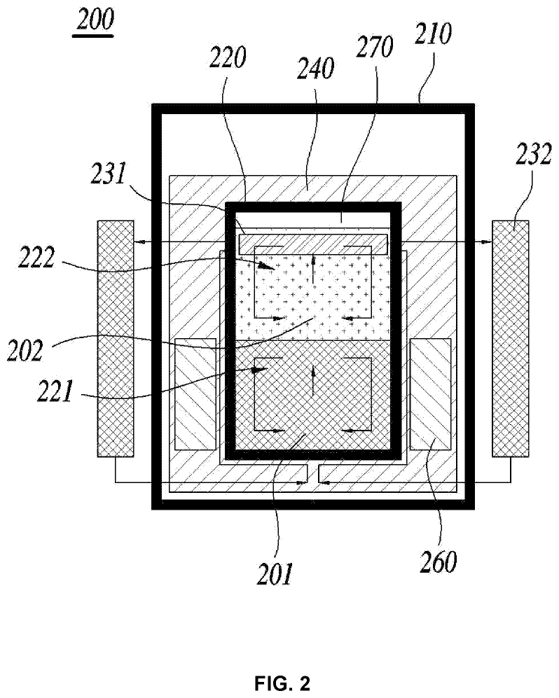

FIG. 2 is a conceptual diagram showing a molten salt-metal reactor (MSMR) 200.

The molten salt-metal reactor (MSMR) 200 according to an embodiment includes a liquid metal nuclear fuel 201 and a molten salt coolant 202, and has a structure in which the molten salt coolant 202 is disposed in an upper portion of the metal nuclear fuel 201 in a liquid phase while forming a liquid-liquid interface, and the molten salt-metal reactor (MSMR) is characterized in that the heat generated in the nuclear fuel 201 during the operation of the reactor is transferred to the molten salt coolant 202 by the heat conduction of the nuclear fuel, convection by natural circulation, radiative heat transfer, and the like.

The liquid metal nuclear fuel 201 according to an embodiment is a uranium-metal alloy, preferably a uranium-metal alloy including uranium with a low degree of enrichment to exhibit a high fuel conversion ratio, wherein the uranium preferably has a degree of enrichment of 19.75% or less.

As an example, the uranium-metal alloy may include uranium having a degree of enrichment of 12% to 15%.

At this time, the degree of enrichment refers to a mass ratio of U-235 in the total uranium (U-235 and U-238).

In addition, it is preferable that the uranium-metal alloy has a composition ratio at an eutectic point or near the eutectic point to maintain the liquid state, and in order to achieve a high fuel conversion ratio, it is more preferable that the uranium-metal alloy contains uranium in 50 wt % or greater, preferably 70 wt % to 99 wt %, 80 wt % to 99 wt %, 85 wt % to 97 wt %, or 89 wt % to 95 wt %, or contains in 60 mol % to 90 mol %, or 65 mol % to 85 mol % in the composition ratio at the eutectic point or near the eutectic point.

The uranium-metal alloy may include two or more metals including uranium. As an example, the uranium-metal alloy may be a binary alloy including uranium, or may be a ternary alloy including uranium.

Preferably, the uranium-metal alloy may include a metal selected from the group consisting of Fe, Mn, Cr, Ce, Pu, and a combination thereof, and preferably, may include a metal selected from the group consisting of Fe, Mn, Cr, Ce, Pu, and a combination thereof, but may have a composition ratio with uranium at or near an eutectic point.

As an example, the uranium-metal alloy may be a binary alloy of uranium (U) and iron (Fe), or a ternary alloy of uranium (U), cerium (Ce), and iron (Fe). In addition, the uranium-metal alloy may include plutonium (Pu) to lower a melting point, relatively.

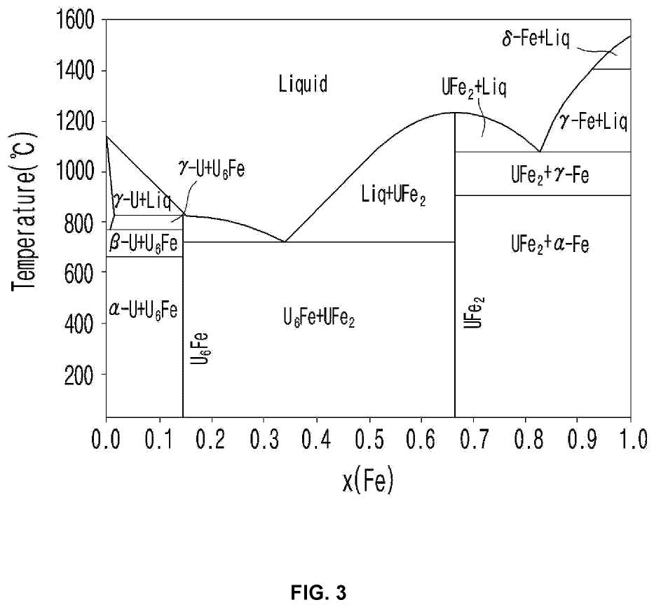

FIG. 3 is an equilibrium phase diagram of uranium (U) and iron (Fe), and as shown in FIG. 3, it can be confirmed that an eutectic reaction occurs at 723° C. when the liquid metal nuclear fuel 201 is a U—Fe alloy, wherein the molar ratio of uranium (U) and iron (Fe) is 66:34 (mass ratio=89:11). In addition, eutectic points for U—Mn and U—Cr, and the molar ratios and mass ratios at the eutectic points are shown in Table 1 below.

TABLE 1

| | Molar ratio | Mass ratio | Melting point |
|---|---|---|---|
| U—Fe | 66:34 | 89:11 | 723° C. |
| U—Mn | 78.5:21.5 | 94:6 | 716° C. |
| U—Cr | 81:19 | 95:5 | 860° C. |

As an example, the metal nuclear fuel 201 may be an U—Fe alloy having a molar ratio of U and Fe of 60:40 to 70:30, an U—Mn alloy having a molar ratio of U and Mn of 70:30 to 80:20, or an U—Cr alloy having a molar ratio of U and Cr of 75:25 to 95:15.

A molten salt coolant 202 according to an embodiment may include an ionic compound of a metal cation and an anion.

At this time, the metal cation includes an alkali metal, an alkali earth metal, or a transition metal, and the anion includes a halogen anion, a hydroxide anion, an oxygen anion, a sulfur anion, a nitrate anion, a sulfate anion, or a phosphate anion, but the embodiment is not limited thereto.

The molten salt coolant 202 according to an embodiment may include one selected from the group consisting of NaCl, MgCl₂, KCl, ZnCl₂, NaOH, NaF, KF, ZrF₄, LiF, BeF₂, and a mixture thereof, and the mixture preferably has a composition ratio at an eutectic point or near the eutectic point in order to maintain the liquid state.

As shown in FIG. 2, the molten salt-metal reactor (MSMR) 200 according to an embodiment may include a containment vessel 210, a reactor vessel 220 including a lower region 221 disposed inside the containment vessel 210 and having the liquid metal nuclear fuel 201 and an upper region 222 having the molten salt coolant 202, a primary heat exchanger 231 disposed in the upper region 222 of the reactor vessel 220, a neutron reflector 240 surrounding the outer side of the reactor vessel 220, and a reactivity control device 260 disposed between the inner wall of the containment vessel 210 and the outer wall of the reactor vessel 220.

At this time, the containment vessel 210 is a facility for preventing the leakage of radioactive materials generated during the operation of a nuclear reactor to the outside, and may be composed of various materials used in typical reactor containment vessels, such as stainless steel.

The reactor vessel 220 is a cylinder type and may be made of a material that has excellent material compatibility with a liquid metal nuclear fuel and a molten salt for withstanding high operating temperatures above 700° C. Therefore, Ta may be preferably used, but in view of the fact that Ta is expensive, the reactor vessel 220 may be manufactured in a structure in which the inner surface thereof is coated with Ta while being composed of Hastelloy-N which has excellent material compatibility.

Through the structure in which the liquid metal nuclear fuel 201 is disposed in the lower region 221 of the reactor vessel 220, and the molten salt coolant 202 is disposed in the upper region 222 forming the liquid-liquid interface with the liquid metal nuclear fuel 201, the molten salt-metal reactor (MSMR) 200 according to an embodiment allows heat generated in the nuclear fuel 201 to be removed by natural circulation of the molten salt coolant 202.

Depending on the design purpose, in the molten salt-metal reactor (MSMR) 200 according to an embodiment, the size of the lower region 221 of a reactor vessel in which the liquid metal nuclear fuel 201 is disposed may be optimized.

Specifically, in order to minimize the inventory of a nuclear fuel, the lower region 221 of a cylinder-type reactor vessel, the lower region 221 in which the nuclear fuel is disposed, may be designed to have a ratio H/D of a height H to a diameter D of 0.8 to 1.2, more preferably 0.9 to 1.1, and more preferably 1.

Alternatively, in order to maximize the area of heat transfer, the lower region 221 of a cylinder-type reactor vessel, the lower region 221 in which the nuclear fuel is disposed, may be designed such that the diameter D is relatively greater than the height H.

In addition, the molten salt-metal reactor (MSMR) 200 according to an embodiment may further include a pump device configured to circulate the molten salt coolant 202.

The pump device may cool heat more effectively by circulating the molten salt coolant 202 faster, so that the output of the reactor may increase.

In addition, in the upper region 222 of the reactor vessel 220, preferably in an upper portion of the molten salt coolant 202, the primary heat exchanger 231 is disposed, through which heat received at the liquid-liquid interface with the metal nuclear fuel 201 may be transferred to the outside or to a secondary heat exchanger 232 to be described later.

The molten salt-metal reactor (MSMR) 200 according to an embodiment may further include a gas plenum 270 which is disposed at the uppermost end of the reactor vessel 220 and stores an inert gas produced by nuclear fission.

The gas plenum 270 may act to allow thermal expansion of the molten salt coolant 202 and the nuclear fuel 201 to occur freely and store an inert gas among nuclear fission products in the corresponding space.

In addition, the molten salt-metal reactor (MSMR) 200 according to an embodiment may further include an off-gas system connected to the gas plenum 270, and through the off-gas system, the inert gas may be removed from the reactor 200.

The molten salt-metal reactor (MSMR) 200 according to an embodiment may further include the secondary heat exchanger 232 as a component connected to the primary heat exchanger 231.

The molten salt-metal reactor (MSMR) 200 according to an embodiment has a structure in which the primary heat exchanger 231 and the secondary heat exchanger 232 are connected as shown in FIG. 2, and may cool heat inside and outside of the reactor vessel through the primary and secondary heat exchangers 231 and 232.

Specifically, the molten salt-metal reactor (MSMR) 200 according to an embodiment may include a secondary coolant system in which a coolant circulates through the first heat exchanger, the second heat exchanger, the outer surface of the reactor vessel, and the first heat exchanger.

The secondary coolant system has a structure in which a coolant is circulated by being transferred from the primary heat exchanger 231 which is inside the reactor vessel 220 to the secondary heat exchanger 232 which is outside the containment vessel 210, and then transferred from a lower portion to an upper portion of the external surface of the reactor vessel 220, followed by being transferred back to the primary heat exchanger 232, and the secondary coolant system may remove heat, which has been received from the primary heat exchanger 231, through the secondary heat exchanger 232, and may directly cool the external surface of the reactor vessel 220 through the coolant which has been cooled in the secondary heat exchanger 232.

At this time, as a coolant used in the secondary coolant system, a molten salt (secondary molten salt coolant) may be used, and the molten salt (secondary molten salt coolant) may be the same as or different from the molten salt coolant (primary molten salt coolant) 202 disposed in the upper region 222 of the reactor vessel 220.

That is, the coolant (secondary molten salt coolant) which circulates the secondary coolant system may be one selected from the group consisting of NaCl, MgCl₂, ZnCl₂, and a mixture thereof, and it is preferable that the mixture has a composition ratio at an eutectic point or near the eutectic point in order to maintain the liquid state.

The molten salt-metal reactor (MSMR) 200 according to an embodiment includes the neutron reflector 240 which surrounds the outer side of the reactor vessel 220, and the reactivity control device 260 disposed between the inner wall of the containment vessel 210 and the outer wall of the reactor vessel 220.

In the molten salt-metal reactor (MSMR) 200 according to an embodiment, since it is difficult to implement a reactivity control device which inserts a control rod into an active core, a drum-type or plate-type reactivity control device may be disposed between the reactor vessel and the containment vessel.

Meanwhile, in a molten salt-metal reactor (MSMR) 200 according to another embodiment, a molten salt coolant including a nuclear fuel salt may be loaded in the upper region 222 of the reactor vessel 220.

That is, the liquid metal nuclear fuel 202 is disposed in the lower region 221 of the reactor vessel 220, and a typical molten salt fuel including a small amount of UCl₃ such as NaCl—MgCl₂—UCl₃ may be disposed in the upper region 222 of the reactor vessel 220, through which the total output of the reactor 200 may be easily increased, and natural circulation in the upper region 222 may be further improved.

In addition, a molten salt-metal reactor (MSMR) 200 according to yet another embodiment may have a structure in which the primary heat exchanger 231 and a Stirling engine are connected excluding the secondary heat exchanger 232 in the structure of FIG. 2, through which a smaller micro-reactor will be implemented.

In addition, a molten salt-metal reactor (MSMR) 300 according to still another embodiment may implement a higher-output reactor by disposing a plurality of reactor vessels in a modular manner in the containment vessel.

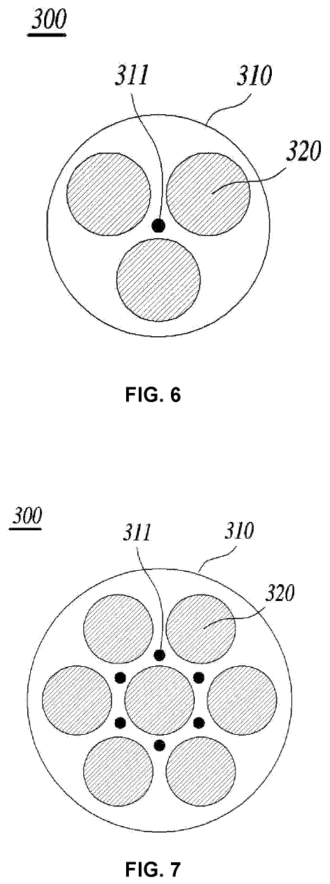

FIG. 6 and FIG. 7 are cross-sectional views schematically showing the molten salt-metal reactor (MSMR) 300 according to still another embodiment, and as shown in FIG. 6, in a modular molten salt-metal reactor, for example, three reactor vessels 320 may be disposed in a triangular shape inside a containment vessel 310, or 7 reactor vessels 320 may be disposed wherein one reactor vessel 320 is surrounded by 6 reactor vessels 320. In addition, in the modular molten salt-metal reactor, since it is difficult to implement a drum-type reactivity control device in a space between reactor vessels, a plate-type or cylinder-type reactivity control device may be disposed.

In addition, a molten salt-metal reactor (MSMR) 400 according to still yet another embodiment may have a structure including a plurality of heat pipes connected to the primary heat exchanger in the reactor vessel excluding the secondary heat exchanger in the structure of FIG. 2.

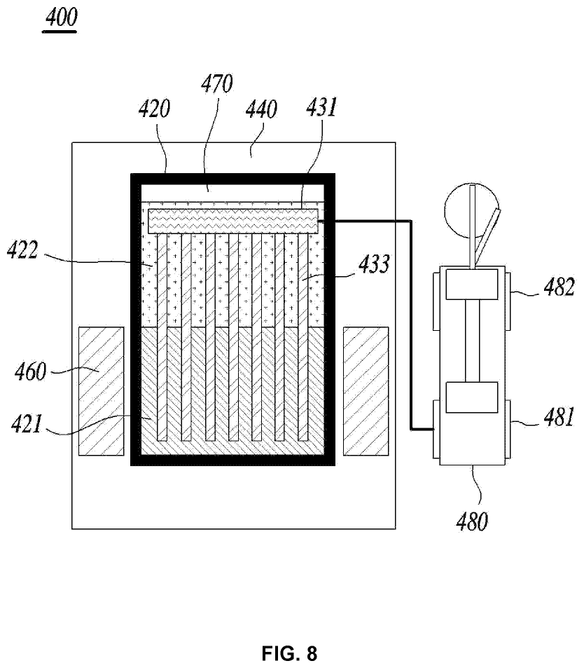

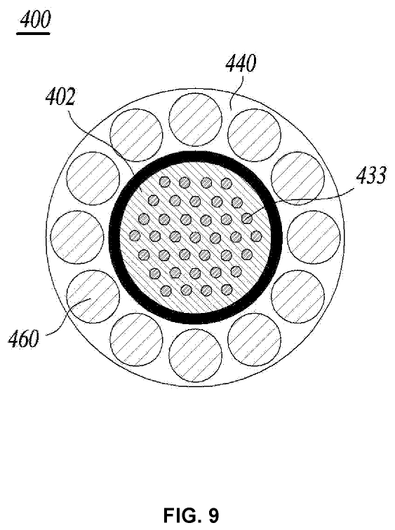

FIG. 8 and FIG. 9 are cross-sectional views schematically showing the molten salt-metal reactor (MSMR) 400 according to still yet another embodiment, and as shown in FIG. 8 and FIG. 9, the molten salt-metal reactor (MSMR) 400 includes a plurality of heat pipes 433 formed by extending from a lower region 421 to an upper region 422 of a reactor vessel 420, wherein the plurality of heat pipes 433 may have a structure of being connected to a primary heat exchanger 431.

At this time, the plurality of heat pipes 433 connected to the primary heat exchanger 431 may be disposed, for example, in the uniform form of a triangle inside the reactor vessel 420. In addition, in the pipe 433, a metal having a low melting point such as sodium may be disposed to cause boiling to occur in the lower region 421 of the reactor vessel 420 in which a metal fuel is disposed and cause condensation to occur in the upper heat exchanger 431 to transfer heat generated from the metal fuel to the primary heat exchanger 431.

In addition, the heat transferred to the primary heat exchanger 431 may be transferred to the outside, and as an example, as illustrated in FIG. 8, the primary heat exchanger 431 may be connected to the Stirling engine.

The molten salt-metal reactor (MSMR) 400 has a structure of being cooled through the heat pipe, and may be implemented as a reactor with a simpler structure, which is advantageous in being used even under conditions where it is difficult to utilize natural circulation, such as in space.

The molten salt-metal reactor (MSMR) 200 according to an embodiment may be implemented as a low-enriched uranium-based ultra-long-life micro-reactor with a high conversion ratio through the above-described structure.

In addition, by using the molten salt-metal reactor (MSMR) according to an embodiment, the following safety benefits may be obtained.

Among nuclear fission products generated from a metal nuclear fuel of the molten salt-metal reactor (MSMR) according to an embodiment, Cs, I, etc., which have a high degree of radioactive hazard and high volatility, have high solubility for the molten salt coolant 202 disposed in the upper region of the reactor vessel 220, and thus, move from a metal to a molten salt. However, since the molten salt coolant 202 keeps radioactive materials such as Cs, I, etc., if the nuclear fuel leaks, the advantage of a typical molten salt reactor (MSR) is that the release of radioactive materials into the atmosphere is significantly inhibited still remains. In addition, even if the nuclear fuel leaks to the outside, the leaked nuclear fuel is rapidly solidified due to the high melting point of the nuclear fuel, so that the emission of radioactive materials may be prevented.

In addition, among nuclear fission products, inert gases from a lower region of a reactor vessel, which is a nuclear fuel region, to an upper region of the reactor vessel, which is a molten salt coolant region, so that the inert gases may be managed through a gas plenum and an off-gas system, and since zirconium is not used as a structural material, explosive gases such as hydrogen are not generated.

In addition, about ½ of the nuclear fission products excluding inert gases and noble metals have high solubility for the molten salt coolant 202, so that the nuclear fission products are not concentrated in a lower region of the reactor but are uniformly distributed in an upper region thereof, through which decay heat may be effectively removed.

Hereinafter, the present invention will be described in detail with reference to an experimental example.

However, the following experimental example is only illustrative of the present invention, and the contents of the present invention are not limited to the following experimental example.

### Experimental Example

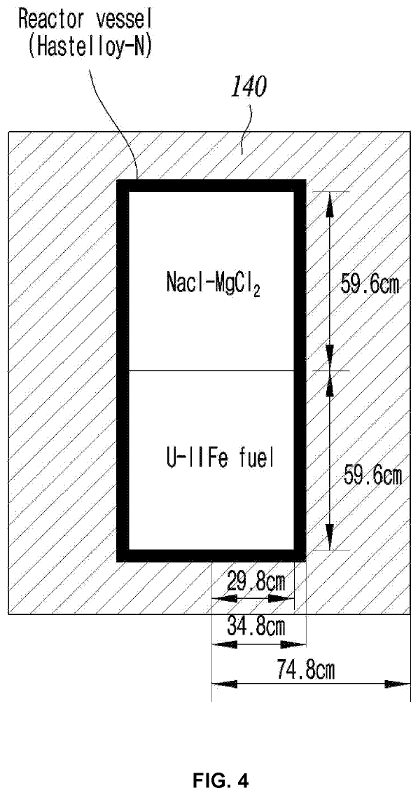

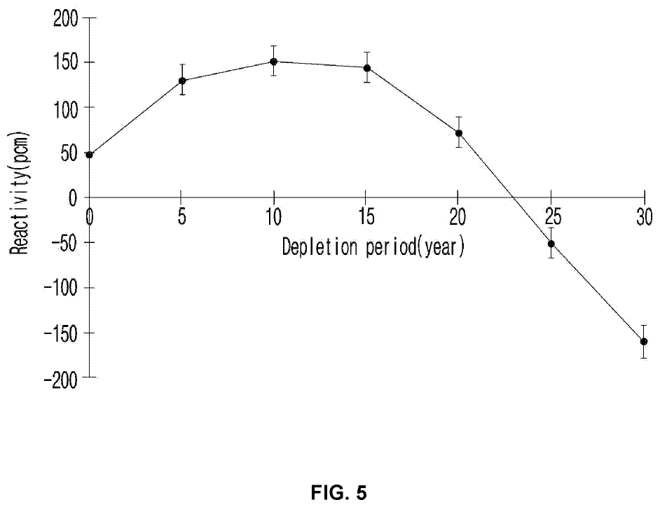

In order to evaluate the reactivity and possibility of long-term operation of a molten salt-metal reactor (MSMR) according to an embodiment, a computational calculation was conducted using Serpent 2, which is a Monte Carlo-based core analysis computer code. The specifications of a molten salt-metal reactor used for the calculation are shown in FIG. 4, and the main design parameters are presented in Table 2 below. For a simple analysis, the core structure was simplified, and a heat exchanger, a secondary system, etc., which do not have a significant impact on the core analysis were omitted, and the analysis results are shown in FIG. 5 and Table 3 below.

TABLE 2

| Liquid metal | U—Fe | | Molten salt | NaCl—MgCl₂ | |
|---|---|---|---|---|---|
| nuclear fuel | (mass ratio | | | | |
| | 89:11) | | | | |
| Degree of uranium | 12% | | Mass of | 2,267 | kg |
| enrichment | | | uranium | | |
| Temperature of | 1,000° | C. | Temperature of | 700° | C. |
| nuclear fuel | | | molten salt | | |
| Output | 10 | MWth | Combustion | 30 | years |
| | | | period | | |

When the molten salt-metal reactor (MSMR) according to an embodiment utilizes uranium with a degree of enrichment of 12%, the diameter and the height of an active core region required to achieve criticality, that is, a lower region of the reactor vessel in which the liquid metal nuclear fuel is disposed, are evaluated to be about 60 cm.

When compared to a typical molten salt reactor (MSR) using uranium with a higher degree of enrichment of 19.75% and based on NaCl—UCl₃ and KCl—UCl₃, the molten salt-metal reactor (MSMR) has a very small size, a size small enough to be loaded into a common container with a width of 230 cm or less and a height of 230 to 260 cm, even with a device such as a reflector.

In addition, the molten salt-metal reactor (MSMR) according to an embodiment has a high ratio of uranium of approximately 89% in a liquid metal nuclear fuel, and a low degree of enrichment of U-235, and thus, a high concentration of U-238, so that a high conversion ratio is ensured.

Accordingly, even without a blanket which is used to increase a fuel conversion ratio, the proliferated nuclear fuel may be used readily, which is advantageous for long-life operation while maintaining a very flat excess reactivity over time.

In addition, for the criticality of the reactor, the amount of nuclear fuel required for criticality while using uranium with a degree enrichment of approximately 12% is only about 2.3 tons, which is significantly reduced to 1/10 or less from 20 to 30 tons, the amount of nuclear fuel required for criticality while using uranium with a degree of enrichment of 19.75% in a typical standard molten salt reactor, so that nuclear fuel-related costs may be significantly reduced.

If uranium with a higher degree of enrichment is used, the size of the reactor for criticality may be further decreased, and the mass of fuel required for the reactor may be further reduced, so that the nuclear fuel-related costs may be further reduced. However, if the neutron leakage increases or the conversion ratio decreases, the lifespan of the reactor may be reduced when the same power is used, so it is preferable that the degree of enrichment of uranium is properly adjusted for use.

FIG. 5 is a graph showing changes in core reactivity when a molten salt-metal reactor (MSMR) having the structure of FIG. 4 is burned with a thermal output of 10 MW for 30 years, and Table 3 is a table showing the burn-up and core conversion ratio of a corresponding nuclear fuel.

As shown in FIG. 5, the initial excess reactivity is about 50 pcm, but the maximum reactivity increment during 10 years of operation is only about 150 pcm due to sufficient nuclear fuel conversion from a liquid metal nuclear fuel. Thereafter, the concentration of U-238, which is a convertible fuel, decreased, and the reactivity decreased due to the accumulation of nuclear fission products which absorb neutrons, so that the reactor became uncritical from about 23 years onwards. As shown in FIG. 5, the maximum reactivity for the entire lifespan of the reactor is about 300 pcm, and as a result, it can be confirmed that the reactor is capable of long-term operation for approximately 20 years while keeping the reactivity changes to be small. From the above results, it can be seen that long-life operation is possible without artificial reprocessing and reinjection of a nuclear fuel.

In addition, as shown in Table 3 below, from the results of the evaluation of the burn-up and fuel conversion ratio, it can be confirmed that the conversion ratio is evaluated to be around 0.7, which means that for every U-235 consumed, about 0.7 Pu-239 or Pu-241 is generated, and it shows that despite the small core size, the fuel conversion is efficiently achieved due to a high fuel density. Meanwhile, the generation of the Pu during the operation has the effect of continuously decreasing the melting point of a lower liquid metal.

TABLE 3

| Combustion period [year] | Burn-up [MWD/kgU] | Conversion ratio |
|---|---|---|
| 0 | 0.00 | 0.677 |
| 5 | 8.06 | 0.686 |
| 10 | 16.11 | 0.694 |
| 15 | 24.17 | 0.703 |
| 20 | 32.23 | 0.712 |
| 25 | 40.29 | 0.721 |
| 30 | 48.34 | 0.729 |

According to the above results, the molten salt-metal reactor (MSMR) of an embodiment is a micro-reactor, which may be operated for a long period of time without reprocessing and reinjection, and also, may be loaded into a container and be easily transported while exhibiting a high burn-up and a high fuel conversion ratio, so that it is expected that the molten salt-metal reactor (MSMR) may be used in various industrial fields including space reactors.

Compared to a typical molten salt reactor (MSR), a molten salt-metal reactor (MSMR) of the present invention uses a denser nuclear fuel and thus has a higher conversion ratio, through which a low-enriched uranium-based ultra-long-life micro-reactor may be implemented.

The molten salt-metal reactor (MSMR) of the present invention may use a smaller amount of nuclear fuel based on low-enriched uranium for criticality, and thus is advantageous in commercialization due to low fuel costs.

The molten salt-metal reactor (MSMR) of the present invention is designed to have a structure in which a molten salt coolant is disposed in an upper portion of a liquid metal nuclear fuel and thus has the advantage of being capable of long-life operation without artificial nuclear fuel reprocessing and reinjection, while maintaining a change in reactivity according to burn-up to a minimum.

The molten salt-metal reactor (MSMR) of the present invention is a micro-reactor easily transportable in a container, and is expected to be widely used in various fields such as the space industry.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

What is claimed is:

1. A molten salt-metal reactor comprises a liquid metal nuclear fuel and a molten salt coolant, wherein the molten salt coolant is disposed in an upper portion of the liquid metal nuclear fuel such that the heat generated from the nuclear fuel is transferred to the molten salt coolant and cooled.

2. The molten salt-metal reactor of claim 1, wherein the liquid metal nuclear fuel is a uranium-metal alloy.

3. The molten salt-metal reactor of claim 2, wherein the uranium-metal alloy comprises uranium having a degree of enrichment of 19.75% or less.

4. The molten salt-metal reactor of claim 2, wherein the uranium-metal alloy contains the uranium in an amount of 70 wt % to 99 wt % based on the total weight.

5. The molten salt-metal reactor of claim 2, wherein the uranium-metal alloy comprises one metal selected from the group consisting of Fe, Mn, Cr, Ce, Pu, and a combination thereof.

6. The molten salt-metal reactor of claim 1, wherein the molten salt coolant comprises one selected from the group consisting of NaCl, MgCl₂, KCl, ZnCl₂, NaOH, NaF, KF, ZrF₄, LiF, BeF₂, and a mixture thereof.

7. The molten salt-metal reactor of claim 1, wherein the molten salt-metal reactor comprises:
a containment vessel;
a reactor vessel disposed inside the containment vessel, and including a lower region which includes the liquid metal nuclear fuel and an upper region which includes the molten salt coolant;
a primary heat exchanger disposed in the upper region of the reactor vessel;
a neutron reflector surrounding the outside of the reactor vessel; and
a reactivity control device disposed between the inner wall of the containment vessel and the outer wall of the reactor vessel.

8. The molten salt-metal reactor of claim 7, wherein the molten salt-metal reactor further comprises a gas plenum disposed at the uppermost end of the reactor vessel, and storing an inert gas produced by nuclear fission.

9. The molten salt-metal reactor of claim 8, wherein the molten salt-metal reactor further comprises an off-gas system connected to the gas plenum.

10. The molten salt-metal reactor of claim 7, wherein the molten salt-metal reactor further comprises a pump device configured to circulate the molten salt coolant.

11. The molten salt-metal reactor of claim 7, wherein the molten salt-metal reactor further comprises a secondary heat exchanger connected to the primary heat exchanger.

12. The molten salt-metal reactor of claim 11, wherein the molten salt-metal reactor further comprises a secondary coolant system in which a coolant circulates through the first heat exchanger, the second heat exchanger, the outer surface of the reactor vessel, and the first heat exchanger.

13. The molten salt-metal reactor of claim 1, wherein the molten salt coolant is a molten salt including a nuclear fuel salt.

14. The molten salt-metal reactor of claim 7, wherein the molten salt-metal reactor comprises a plurality of the reactor vessels.

15. The molten salt-metal reactor of claim 7, wherein the molten salt-metal reactor further comprises a plurality of heat pipes formed by extending from the upper region to the lower region of the reactor vessel, wherein the plurality of heat pipes is connected to the primary heat exchanger.

16. The molten salt-metal reactor of claim 1, wherein the molten salt-metal reactor is a micro-reactor.
